(19) United States
(12) Patent Application Publication
(10) Pub. No.: US 2015/0316885 A1
(43) Pub. Date: Nov. 5, 2015

(54) IMAGE FORMING APPARATUS AND IMAGE FORMING METHOD

(71) Applicants: Yuuichiroh Uematsu, Kanagawa (JP); Shinichi Akatsu, Kanagawa (JP); Tetsuya Muto, Tokyo (JP)

(72) Inventors: Yuuichiroh Uematsu, Kanagawa (JP); Shinichi Akatsu, Kanagawa (JP); Tetsuya Muto, Tokyo (JP)

(21) Appl. No.: 14/690,645

(22) Filed: Apr. 20, 2015

(30) Foreign Application Priority Data
May 2, 2014 (JP) 2014-095394

(51) Int. Cl. G03G 15/00

(52) U.S. Cl. CPC G03G 15/556; G03G 15/16

(57) ABSTRACT

An image forming apparatus includes a controller to perform a primary image forming condition determination control to determine a primary image forming condition for each of a plurality of image forming devices in a multi-color image forming mode based on a toner adhesion amount adhered to a transferred image bearer that is detected by a toner adhesion detector and a secondary image forming condition determination control to determine a secondary image forming condition for a particular at least one of the plurality of image forming devices in a particular color image forming mode based on the toner adhesion amount. The controller performs the primary image forming condition determination control at a predetermined time and determines whether or not to perform the secondary image forming condition determination control based on the toner adhesion amount detected under the primary image forming condition determination control.

### CROSS-REFERENCE TO RELATED APPLICATION

This patent application is based on and claims priority pursuant to 35 U.S.C. §119 to Japanese Patent Application No. 2014-095394, filed on May 2, 2014, in the Japanese Patent Office, the entire disclosure of which is hereby incorporated by reference herein.

### BACKGROUND

1. Technical Field

Exemplary aspects of the present disclosure relate to an image forming apparatus and an image forming method, and more particularly, to an image forming apparatus and an image forming method for forming a toner image on a recording medium.

2. Description of the Background

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such image forming apparatuses may include four image forming devices that form yellow, magenta, cyan, and black toner images, respectively, to be transferred onto a transferred image bearer. The yellow, magenta, cyan, and black toner images are superimposed on a same position on the transferred image bearer to form a full color toner image thereon.

The image forming apparatuses may provide a plurality of image forming modes or print modes, for example, a monochrome mode, a full color mode, and a bicolor mode. If the monochrome mode is selected, the three image forming devices that form the yellow, magenta, and cyan toner images, respectively, are stopped and the image forming device that forms the black toner image is driven.

The image forming devices that form the yellow, magenta, and cyan toner images, respectively, as they are not used in the monochrome mode, may be isolated from the transferred image bearer to prevent them from damaging the black toner image formed on the transferred image bearer.

### SUMMARY

This specification describes below an improved image forming apparatus. In one exemplary embodiment, the image forming apparatus includes a transferred image bearer movable in a predetermined direction of motion and a plurality of image forming devices arranged in the direction of motion of the transferred image bearer, each of which includes a pre-transfer image bearer to bear a toner image to be transferred onto the transferred image bearer. A toner adhesion detector is disposed opposite the transferred image bearer to detect a toner adhesion amount of toner of the toner image adhered to the transferred image bearer. A controller is operatively connected to the plurality of image forming devices and the toner adhesion detector to selectively perform a multi-color image forming mode that forms the toner image with the plurality of image forming devices and a particular color image forming mode that forms the toner image with a particular at least one of the plurality of image forming devices. The controller performs a primary image forming condition determination control to form the toner image for multi-color image density adjustment on the transferred image bearer with the plurality of image forming devices, detects the toner adhesion amount of the toner of the toner image for multi-color image density adjustment with the toner adhesion detector, and determines a primary image forming condition for each of the plurality of image forming devices in the multi-color image forming mode based on the toner adhesion amount detected by the toner adhesion detector and a secondary image forming condition determination control to form the toner image for particular color image density adjustment on the transferred image bearer with the particular at least one of the plurality of image forming devices, detect the toner adhesion amount of the toner of the toner image for particular color image density adjustment with the toner adhesion detector, and determine a secondary image forming condition for the particular at least one of the plurality of image forming devices in the particular color image forming mode based on the toner adhesion amount detected by the toner adhesion detector. The controller performs the primary image forming condition determination control at a predetermined time and determines whether or not to perform the secondary image forming condition determination control based on the toner adhesion amount detected by the toner adhesion detector under the primary image forming condition determination control.

This specification further describes an improved image forming method. In one exemplary embodiment, the image forming method includes setting a flag for executing an image density control; performing a primary image forming condition determination control to drive a plurality of image forming devices; calculating a developing capacity and a primary image forming condition for each of the plurality of image forming devices; comparing a latest calculation value with a previous calculation value of the developing capacity and the primary image forming condition for an upstream image forming device disposed upstream from other image forming devices of the plurality of image forming devices in a direction of motion of a transferred image bearer; determining that a difference between the latest calculation value and the previous calculation value is not smaller than a threshold; and performing a secondary image forming condition determination control to drive the upstream image forming device.

### BRIEF DESCRIPTION OF THE DRAWINGS

A more complete appreciation of the disclosure and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an exemplary embodiment of the present disclosure;

FIG. 2 is a schematic vertical sectional view of an image forming device incorporated in the image forming apparatus shown in FIG. 1;

FIG. 3 is a block diagram illustrating a control system incorporated in the image forming apparatus shown in FIG. 1;

FIG. 4 is a flowchart showing an image density control conducted by a controller of the control system shown in FIG. 3;

FIG. 5A is a flowchart showing a control for setting an image forming condition in a print mode other than a clear print mode; and

FIG. 5B is a flowchart showing a control for setting the image forming condition in the clear print mode.

### DETAILED DESCRIPTION OF THE DISCLOSURE

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner and achieve a similar result.

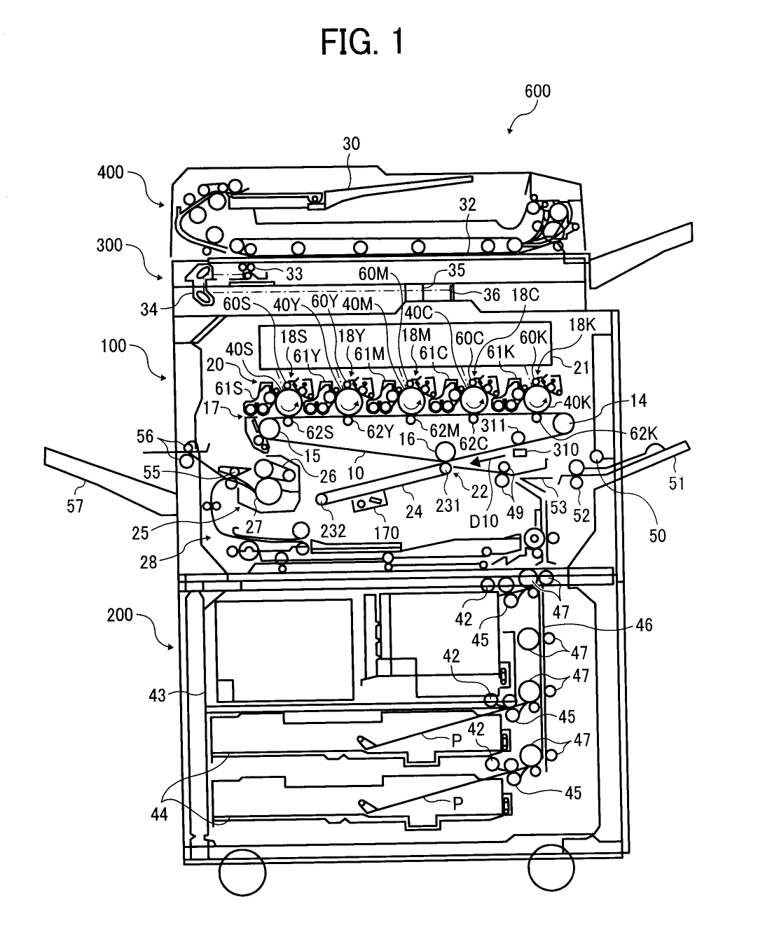

Referring now to the drawings, wherein like reference numerals designate identical or corresponding parts throughout the several views, in particular to FIG. 1, a copier 600 serving as an image forming apparatus according to an exemplary embodiment of the present disclosure is explained.

It is to be noted that, in the drawings for explaining exemplary embodiments of this disclosure, identical reference numerals are assigned, as long as discrimination is possible, to components such as members and component parts having an identical function or shape, thus omitting description thereof once it is provided.

FIG. 1 is a schematic vertical sectional view of the copier 600 serving as an image forming apparatus. The image forming apparatus may be a copier, a facsimile machine, a printer, a multifunction peripheral or a multifunction printer (MFP) having at least one of copying, printing, scanning, facsimile, and plotter functions, or the like.

A description is provided of a construction of the copier 600 serving as an image forming apparatus.

The image forming apparatus shown in FIG. 1, that is, the copier 600, includes five image forming devices that form clear, yellow, magenta, cyan, and black toner images with five toners, that is, clear (S), yellow (Y), magenta (M), cyan (C), and black (K) toners, respectively. Alternatively, the image forming apparatus may include four or less image forming devices or six or more image forming devices. That is, the present disclosure is also applicable to image forming apparatuses incorporating image forming devices that perform image formation with toners other than the five toners described above, four or less image forming devices, or six or more image forming devices.

As shown in FIG. 1, the copier 600 is a tandem image forming apparatus that forms a toner image on a recording medium by electrophotography in an indirect or intermediate transfer method. The copier 600 includes a printer portion 100 constituting a body of the copier 600, a sheet feeder 200 (e.g., a sheet table) situated below the printer portion 100, a scanner 300 situated above the printer portion 100, and an auto document feeder (ADF) 400 situated above the scanner 300. The sheet feeder 200 mounting the printer portion 100 serves as a recording medium supply that supplies a recording medium (e.g., a transfer sheet P) to the printer portion 100. The scanner 300 mounted on the printer portion 100 serves as a reading device that reads an image on an original. The ADF 400 mounted on the scanner 300 serves as an original conveyer that conveys the original to the scanner 300.

A detailed description is now given of a construction of the printer portion 100.

The printer portion 100 serving as a transferor or an intermediate transferor includes an intermediate transfer belt 10, that is, an endless belt, situated in a center part of the printer portion 100. The intermediate transfer belt 10, serving as a transferred image bearer, is looped over three support rotators, that is, a first support roller 14, a second support roller 15, and a third support roller 16, and rotatable clockwise in FIG. 1 in a rotation direction D10. On the left of the second support roller 15 is an intermediate transfer belt cleaner 17 serving as a cleaner that removes residual toner failed to be transferred onto a transfer sheet P and therefore remaining on the intermediate transfer belt 10 therefrom. A tandem image forming portion 20 is disposed opposite a part of the intermediate transfer belt 10 bridging the first support roller 14 and the second support roller 15. The tandem image forming portion 20 includes five image forming devices 18S, 18Y, 18M, 18C, and 18K arranged in the rotation direction D10 of the intermediate transfer belt 10 to form clear, yellow, magenta, cyan, and black toner images, respectively.

The third support roller 16 is a driving roller driven and rotated by a driver, thus rotating the intermediate transfer belt 10 by friction between the third support roller 16 and the intermediate transfer belt 10. A toner adhesion sensor 310 serving as a toner adhesion detector that detects an amount of toner of the toner image adhered to the intermediate transfer belt 10 is disposed opposite a part of the intermediate transfer belt 10 bridging the first support roller 14 and the third support roller 16. For example, the toner adhesion sensor 310 is an optical sensor using reflection of light. The toner adhesion sensor 310 is disposed opposite a backup roller 311 via the intermediate transfer belt 10. The backup roller 311 is a sensor opposed rotator contacting a back face, that is, an inner circumferential surface, of the intermediate transfer belt 10 to support the intermediate transfer belt 10.

Above the tandem image forming portion 20 is an exposure device 21. The tandem image forming portion 20 is disposed opposite a secondary transfer device 22 serving as a secondary transferor via the intermediate transfer belt 10. The secondary transfer device 22 includes a secondary transfer belt 24 and two secondary transfer belt support rollers 231 and 232. The secondary transfer belt 24 is an endless belt serving as a recording medium conveyor looped over the secondary transfer belt support rollers 231 and 232. The secondary transfer belt 24 is pressed against the third support roller 16 via the intermediate transfer belt 10. The secondary transfer device 22 secondarily transfers the toner image formed on the intermediate transfer belt 10 onto the transfer sheet P. Below the secondary transfer belt 24 is a secondary transfer belt cleaner 170 that cleans an outer circumferential surface of the secondary transfer belt 24.

On the left of or downstream from the secondary transfer device 22 in a sheet conveyance direction is a fixing device 25 that fixes the toner image transferred from the intermediate transfer belt 10 onto the transfer sheet P thereon. The fixing device 25 includes a fixing belt 26, that is, an endless belt serving as a fixing rotator or a fixing member that is heated by a heater and a pressure roller 27 serving as a pressure rotator or a pressure member pressed against the fixing belt 26. The secondary transfer device 22 also serves as a sheet conveyer that conveys the transfer sheet P bearing the toner image transferred from the intermediate transfer belt 10 to the fixing device 25.

Downstream from the secondary transfer device 22 and the fixing device 25 in the sheet conveyance direction is a sheet reverse device 28 extending parallel to a longitudinal direction of the tandem image forming portion 20, that is, an arrangement direction of the image forming devices 18S, 18Y, 18M, 18C, and 18K. The sheet reverse device 28 is a recording medium reverse device that reverses the transfer sheet P for duplex printing.

A description is provided of a copy job performed by the copier 600.

A user places an original on an original tray 30 of the ADF 400. Alternatively, the user lifts the ADF 400, places an original on an exposure glass 32 of the scanner 300, lowers the ADF 400 to cause the ADF 400 to press the original against the exposure glass 32. If the user places an original on the original tray 30 of the ADF 400, as the user presses a start button on a control panel, the ADF 400 conveys the original onto the exposure glass 32 and the scanner 300 is actuated. Conversely, if the user places an original on the exposure glass 32, as the user presses the start button on the control panel, the scanner 300 is actuated immediately.

Next, a first carriage 33 and a second carriage 34 of the scanner 300 start moving. A light source mounted on the first carriage 33 emits light to the original on the exposure glass 32 and a mirror mounted on the first carriage 33 reflects the light reflected by the original toward the second carriage 34. A mirror mounted on the second carriage 34 reflects the light to an image reading sensor 36 through an image forming lens 35. The image reading sensor 36 reads the light into image data. Simultaneously with reading, a driving motor serving as a driver drives and rotates the third support roller 16 serving as a driving roller driven and rotated by the driver and thus rotating the intermediate transfer belt 10. Accordingly, the third support roller 16 rotates the intermediate transfer belt 10 clockwise in FIG. 1 by friction between the third support roller 16 and the intermediate transfer belt 10. Consequently, the first support roller 14 and the second support roller 15 serving as driven rollers are rotated by the intermediate transfer belt 10.

Simultaneously, drum-shaped photoconductors 40S, 40Y, 40M, 40C, and 40K, serving as pre-transfer image bearers, of the image forming devices 18S, 18Y, 18M, 18C, and 18K, respectively, are driven and rotated. Chargers 60S, 60Y, 60M, 60C, and 60K charge the photoconductors 40S, 40Y, 40M, 40C, and 40K, respectively. The exposure device 21 exposes the charged photoconductors 40S, 40Y, 40M, 40C, and 40K with light according to clear, yellow, magenta, cyan, and black image data to form electrostatic latent images on the photoconductors 40S, 40Y, 40M, 40C, and 40K, respectively. Developing devices 61S, 61Y, 61M, 61C, and 61K of the image forming devices 18S, 18Y, 18M, 18C, and 18K develop the electrostatic latent images into clear, yellow, magenta, cyan, and black toner images with clear, yellow, magenta, cyan, and black toners, respectively. Thus, the clear, yellow, magenta, cyan, and black images are formed on the five photoconductors 40S, 40Y, 40M, 40C, and 40K, respectively. Primary transfer rollers of primary transfer devices 62S, 62Y, 62M, 62C, and 62K serving as primary transferors primarily transfer the clear, yellow, magenta, cyan, and black toner images formed on the photoconductors 40S, 40Y, 40M, 40C, and 40K successively such that the clear, yellow, magenta, cyan, and black toner images are superimposed on a same position on the intermediate transfer belt 10. Thus, a composite toner image is formed on the intermediate transfer belt 10.

Simultaneously with image formation of the tandem image forming portion 20, one of feed rollers 42 incorporated in the sheet feeder 200 is selectively rotated to pick up and feed a transfer sheet P from one of paper trays 44 layered in a paper bank 43. A separation roller 45 separates the transfer sheet P picked up from the one of the paper trays 44 from other transfer sheets P in the paper tray 44 and feeds the transfer sheet P to a sheet conveyance path 46. A conveyance roller pair 47 conveys the transfer sheet P to a sheet conveyance path inside the printer portion 100 where the transfer sheet P strikes a registration roller pair 49 that halts the transfer sheet P. If the user selects a bypass tray 51 loading a plurality of transfer sheets P, a bypass feed roller 50 rotates and picks up the transfer sheets P from the bypass tray 51 and a bypass separation roller 52 separates an uppermost transfer sheet P from other transfer sheets P and feeds the uppermost transfer sheet P to a sheet conveyance path 53. Like the transfer sheet P supplied from the sheet feeder 200, the transfer sheet P supplied from the bypass tray 51 strikes the registration roller pair 49 that halts the transfer sheet P.

After the transfer sheet P strikes the registration roller pair 49, the registration roller pair 49 starts rotation to feed the transfer sheet P to a secondary transfer nip formed between the intermediate transfer belt 10 and the secondary transfer device 22 at a time when the composite toner image formed on the intermediate transfer belt 10 reaches the secondary transfer nip. As the transfer sheet P is conveyed through the secondary transfer nip, the secondary transfer device 22 secondarily transfers the composite toner image formed on the intermediate transfer belt 10, that is, a color toner image, onto the transfer sheet P.

The transfer sheet P bearing the color toner image is conveyed by the secondary transfer belt 24 to the fixing device 25 where the fixing belt 26 and the pressure roller 27 apply heat and pressure to the transfer sheet P, fixing the color toner image on the transfer sheet P. For one-sided printing, the transfer sheet P bearing the fixed toner image is directed and guided by a switch claw 55 to an output roller pair 56 that ejects the transfer sheet P onto an output tray 57 that stacks the transfer sheet P. Conversely, for duplex printing, the transfer sheet P bearing the fixed toner image is directed and guided by the switch claw 55 to the sheet reverse device 28 that reverses and guides the transfer sheet P to the secondary transfer nip. After another toner image is secondarily transferred from the intermediate transfer belt 10 onto a back side of the transfer sheet P, the transfer sheet P is conveyed to the output roller pair 56 that ejects the transfer sheet P onto the output tray 57.

After the secondary transfer of the color toner image, the intermediate transfer belt cleaner 17 removes residual toner failed to be transferred onto the transfer sheet P and therefore remaining on the intermediate transfer belt 10 therefrom, causing the tandem image forming portion 20 to be ready for a next image forming operation. The registration roller pair 49 is grounded. Alternatively, the registration roller pair 49 may be applied with a bias to remove paper dust from the transfer sheet P.

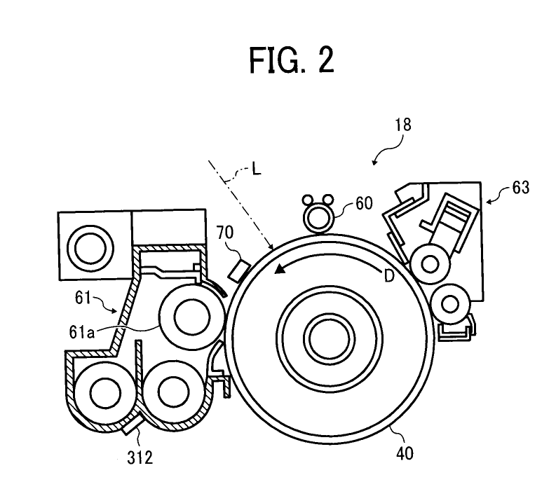

With reference to FIG. 2, a description is provided of a construction of one of the five image forming devices 18S, 18Y, 18M, 18C, and 18K of the tandem image forming portion 20 as one example.

FIG. 2 is a schematic vertical sectional view of an image forming device 18 as one of the five image forming devices 18S, 18Y, 18M, 18C, and 18K depicted in FIG. 1. Since the five image forming devices 18S, 18Y, 18M, 18C, and 18K are substantially identical in construction except for difference in color of toner used therein, suffixes S, Y, M, C, and K for identifying the color of toner are omitted in FIG. 2.

As shown in FIG. 2, the image forming device 18 includes a charger 60, a potential sensor 70 serving as a potential detector, a developing device 61, and a photoconductor cleaner 63 serving as an image bearer cleaner, which surround a drum-shaped photoconductor 40. A discharger is interposed between the photoconductor cleaner 63 and the charger 60 in a rotation direction D of the photoconductor 40.

During an image forming operation, a driving motor drives and rotates the photoconductor 40 in the rotation direction D. After the charger 60 uniformly charges an outer circumferential surface of the photoconductor 40, the exposure device 21 depicted in FIG. 1 emits light L onto the charged outer circumferential surface of the photoconductor 40 according to image data produced by reading the image on the original as described above, for example, thus forming an electrostatic latent image on the photoconductor 40. An image processor performs image processing such as color conversion processing on a color image signal produced based on image data from the scanner 300 to output clear, yellow, magenta, cyan, and black image signals to the exposure device 21. In order to form an electrostatic latent image on the photoconductor 40K to be developed into a black toner image, the exposure device 21 converts the black image signal from the image processor into an optical signal based on which light L from the exposure device 21 irradiates and scans the outer circumferential surface of the uniformly charged outer circumferential surface of the photoconductor 40K, thus forming the electrostatic latent image on the photoconductor 40K. Similarly, an electrostatic latent image is formed on each of the photoconductors 40S, 40Y, 40M, and 40C.

As shown in FIG. 2, the developing device 61 develops an electrostatic latent image formed on the photoconductor 40 into a toner image with a two-component developer, that is, a toner, containing toner particles and magnetic carrier particles. The developing device 61 includes a developing roller 61a serving as a developer bearer that bears the developer. A developing roller driver drives and rotates the developing roller 61a at a predetermined number of rotations. A developing bias applicator (e.g., a developing bias power supply) applies a predetermined developing bias to the developing roller 61a to produce a developing potential, that is, a potential difference between the electrostatic latent image formed on the photoconductor 40 and the developing roller 61a. As the developing potential transfers toner particles on the developing roller 61a onto the electrostatic latent image formed on the photoconductor 40, the toner particles visualize the electrostatic latent image as a toner image (e.g., a clear, yellow, magenta, cyan, or black toner image). A toner density sensor 312 serving as a toner density detector is disposed opposite a bottom face of the developing device 61 below a developer conveyance screw situated inside the developing device 61. The toner density sensor 312 detects the density of fresh toner particles of the two-component developer contained inside the developing device 61 as needed.

As shown in FIG. 1, each of the primary transfer devices 62S, 62Y, 62M, 62C, and 62K (e.g., the primary transfer roller) applied with a predetermined primary transfer bias by a primary transfer bias applicator (e.g., a primary transfer bias supply) primarily transfers the toner image formed on the photoconductor 40 onto the intermediate transfer belt 10. As shown in FIG. 2, after the primary transfer of the toner image, the photoconductor cleaner 63 removes residual toner failed to be transferred onto the intermediate transfer belt 10 and therefore remaining on the photoconductor 40 therefrom. The discharger discharges the photoconductor 40, rendering the photoconductor 40 to be ready for a next job.

The image forming operation described above is performed by the image forming devices 18S, 18Y, 18M, 18C, and 18K to form the clear, yellow, magenta, cyan, and black toner images on the photoconductors 40S, 40Y, 40M, 40C, and 40K, respectively. The clear, yellow, magenta, cyan, and black toner images formed on the photoconductors 40S, 40Y, 40M, 40C, and 40K of the image forming devices 18S, 18Y, 18M, 18C, and 18K, respectively, are primarily transferred onto the intermediate transfer belt 10 such that they are superimposed on a same position on the intermediate transfer belt 10.

A description is provided of image forming modes available in the copier 600.

The image forming modes available in the copier 600 include at least four print modes described below. The four print modes are a full color plus clear mode (hereinafter referred to as a full color plus clear (FCS) print mode), a full color mode (hereinafter referred to as a full color (FC) print mode), a clear mode (hereinafter referred to as a clear (S) print mode), and a black mode (hereinafter referred to as a black (K) print mode). Additionally, the copier 600 may provide a monochrome mode using the single image forming device 18 other than the image forming devices 18S and 18K, a bicolor mode, a tricolor mode, and a quadcolor mode.

The FCS print mode forms a full color toner image by using all of the five image forming devices 18S, 18Y, 18M, 18C, and 18K. The FC print mode forms a full color toner image by using the four image forming devices 18Y, 18M, 18C, and 18K, not using the image forming device 18S that forms a clear toner image. The S print mode forms a monochrome toner image by using the image forming device 18S only. The K print mode forms a monochrome toner image by using the image forming device 18K that forms a black toner image only.

The monochrome mode forms a monochrome toner image by using any one of the three image forming devices 18Y, 18M, and 18C, not using the image forming devices 18S and 18K. The bicolor mode forms a toner image by using any two of the five image forming devices 18S, 18Y, 18M, 18C, and 18K. The tricolor mode forms a toner image by using any three of the five image forming devices 18S, 18Y, 18M, 18C, and 18K. The quadcolor mode forms a toner image by using any three of the four image forming devices 18Y, 18M, 18C, and 18K, other than the image forming device 18S, and the image forming device 18S.

For example, the bicolor mode forms a monochrome toner image (e.g., a monochrome red image, a monochrome blue image, and a monochrome green image), a bicolor toner image created with yellow and black toners, a bicolor toner image created with cyan and black toners, and a bicolor toner image created with magenta and black toners. Further, the bicolor mode forms a monochrome yellow image created with yellow and clear toners, a monochrome cyan image created with cyan and clear toners, a monochrome magenta image created with magenta and clear toners, and a monochrome black image created with black and clear toners. The same is applicable to the tricolor mode and the quadcolor mode.

A description is provided of a configuration of a contact-separate mechanism that brings each of the photoconductors 40S, 40Y, 40M, 40C, and 40K into contact with and separation from the intermediate transfer belt 10 separately from each other.

For example, the contact-separate mechanism includes a driver that moves each of the image forming devices 18S, 18Y, 18M, 18C, and 18K vertically, bringing each of the photoconductors 40S, 40Y, 40M, 40C, and 40K into contact with or separation from the intermediate transfer belt 10. The contact-separate mechanism moves the photoconductors 40S, 40Y, 40M, 40C, and 40K of the image forming devices 18S, 18Y, 18M, 18C, and 18K arbitrarily relative to the intermediate transfer belt 10. The image forming devices 18S, 18Y, 18M, 18C, and 18K used for image formation vary depending on the image forming mode. Accordingly, at least one of the image forming devices 18S, 18Y, 18M, 18C, and 18K not used for image formation is isolated from the intermediate transfer belt 10 during an image forming operation under the selected image forming mode.

A description is provided of reverse transfer that may occur in image forming apparatuses incorporating a plurality of image forming devices.

For example, a first comparative image forming apparatus may include four image forming devices, that is, a yellow image forming device that forms a yellow toner image, a magenta image forming device that forms a magenta toner image, a cyan image forming device that forms a cyan toner image, and a black image forming device that forms a black toner image. For a print job in the bicolor mode using red and black, the four image forming devices may be driven. In this case, a red image is produced by superimposing the magenta toner image formed by the magenta image forming device on the yellow toner image formed by the yellow image forming device. However, although the cyan toner image is unnecessary to form the red image, the cyan image forming device is also driven. If the cyan image forming device is driven, the cyan image forming device may unnecessarily suffer from abrasion of components incorporated therein, degradation of toner, and waste of power. To address this circumstance, it is preferable to deactivate the cyan image forming device not used for the print job.

A second comparative image forming apparatus may include five image forming devices, that is, the yellow, magenta, cyan, and black image forming devices and a clear image forming device that forms a clear toner image with clear toner. The second comparative image forming apparatus provides various print modes by various combinations of the five image forming devices. Hence, the second comparative image forming apparatus is susceptible to usage of print modes that do not require driving of all of the five image forming devices. To address this circumstance, it is advantageous to perform a control that deactivates the image forming devices not used for the print job.

However, under such control, the image density and the color of the toner image may vary depending on the selected print mode. For example, a yellow part of the toner image formed in the bicolor mode is deeper than that formed in the full color mode due to the reasons below.

If the clear, yellow, magenta, cyan, and black image forming devices are arranged in this order in a rotation direction of a transferor like the image forming devices 18S, 18Y, 18M, 18C, and 18K shown in FIG. 1, in the full color mode, the yellow, magenta, cyan, and black image forming devices are driven. While magenta and cyan toner images formed by the magenta and cyan image forming devices, respectively, are transferred onto a transferred image bearer, yellow toner of the yellow toner image already transferred on the transferred image bearer may be transferred back to pre-transfer image bearers of the magenta and the cyan image forming devices, which is called “reverse transfer”, thus decreasing an adhesion amount of yellow toner per unit area adhered to the transferred image bearer (hereinafter referred to as “the toner adhesion amount”).

Conversely, for a print job in the bicolor mode using yellow and black, the magenta and cyan image forming devices are not driven. That is, no magenta and cyan toner images are transferred from the magenta and cyan image forming devices onto the transferred image bearer, causing no reverse transfer of yellow toner to the pre-transfer image bearers of the magenta and cyan image forming devices and therefore causing no decrease in the toner adhesion amount of yellow toner to the transferred image bearer. An image forming condition to address the toner adhesion amount of yellow toner is adjusted by a condition of the full color mode that causes reverse transfer of yellow toner. Accordingly, the yellow toner image in the full color mode susceptible reverse transfer is produced with a target image density and a target color. However, the yellow toner image in the bicolor mode using yellow and black not susceptible to reverse transfer, due to the increased toner adhesion amount of yellow toner to the transferred image bearer, may be produced with an image density deeper than the target image density. For example, red and blue toner images produced by superimposing toner images in two or more colors may be produced with an image density and a color different from the target image density and the target color due to variation in an amount of reverse transfer of toner between the toner images in the two or more colors.

To address this circumstance, the image forming apparatuses may employ an image density control called a process control that calculates an image forming condition to attain a desired toner adhesion amount by producing a plurality of patch patterns having a plurality of toner adhesion amounts different from each other.

The image density control calculates a reverse transfer rate of toner of a toner image transferred from a particular image forming device onto the transferred image bearer and transferred back from the transferred image bearer to other image forming device. The image density control is performed while all of the image forming devices are driven like in the full color mode. In the bicolor mode using yellow and black in which the magenta and cyan image forming devices disposed downstream from the yellow image forming device in a rotation direction of the transferred image bearer are not driven, the image density control changes the image forming condition based on the calculated reverse transfer rate so as to decrease the toner adhesion amount of yellow toner by an amount decreased by reverse transfer of yellow toner to the magenta and cyan image forming devices in the full color mode. Thus, the image density control calculates the image forming condition according to various image forming modes. However, the constant calculated reverse transfer rate is used for the image density control and the reverse transfer rate is susceptible to error factor such as an environment. Hence, the constant reverse transfer rate may degrade accuracy in the image density control.

Alternatively, the image density control may be performed while a part of the image forming devices, not all of the image forming devices, is driven in a particular image forming mode.

For example, before the particular image forming mode that drives a part of the image forming devices is activated, the image density control is performed by driving that part of the image forming devices. In order to perform the image density control according to various image forming modes, the optimum image forming condition is calculated for each image forming mode. However, the image density control produces a plurality of patch patterns having a plurality of different toner adhesion amounts, respectively, wasting toner and consuming time. Additionally, the image density control is performed whenever the image forming mode changes, increasing toner consumption and a waiting time for the user to wait before the image density control or a print job finishes.

A description is provided of a configuration of a control system of the copier 600.

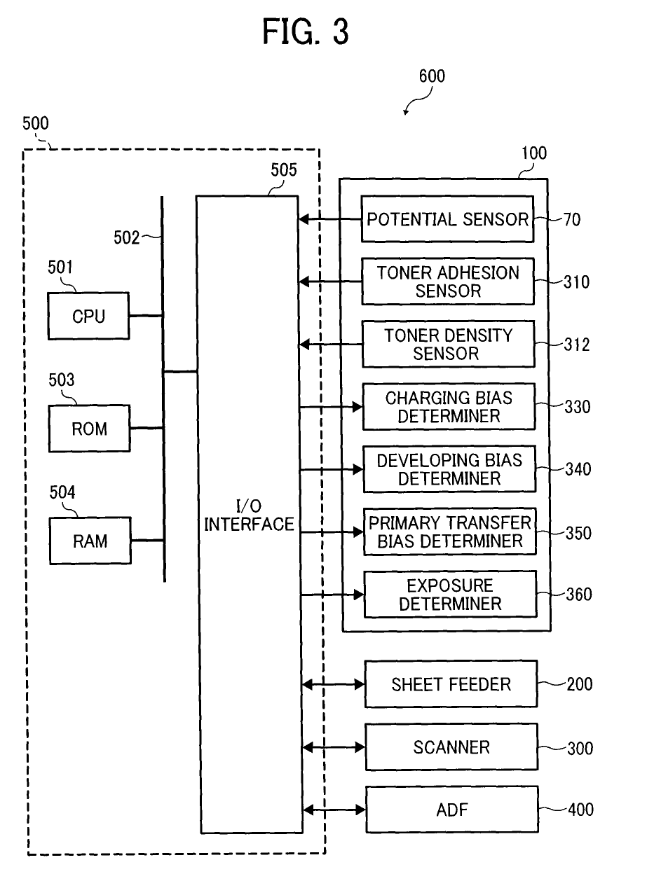

FIG. 3 is a block diagram illustrating one example of a main section of the control system of the copier 600. The copier 600 includes a controller 500. The controller 500 (e.g., a processor) is constructed of a computer such as a micro computer, for example. The controller 500 controls the image forming operation under the plurality of image forming modes including the FCS print mode, the FC print mode, the S print mode, and the K print mode. For example, the controller 500 serves as an image forming controller that controls driving of at least one of the image forming devices 18S, 18Y, 18M, 18C, and 18K depicted in FIG. 1 selected according to the image forming mode. Additionally, the controller 500 serves as an image forming condition determiner that controls determination of an image forming condition to adjust the density of the toner image formed on the transfer sheet P to a target image density.

A detailed description is now given of a configuration of the controller 500.

The controller 500 includes a central processing unit (CPU) 501, a read-only memory (ROM) 503, a random access memory (RAM) 504, and an input/output (I/O) interface 505. The ROM 503 and the RAM 504 constitute a memory connected to the CPU 501 through a bus line 502. The CPU 501, by executing a control program, that is, a preinstalled computer program, performs various calculation and control of driving of various components. The ROM 503 prestores fixed data such as a computer program and control data. The RAM 504 serves as a work area or the like that stores various data in a rewritable format.

Various sensors of the printer portion 100, such as the toner adhesion sensor 310, the toner density sensor 312, and the potential sensor 70, are connected to the controller 500 through the I/O interface 505 to send detection data to the controller 500. A charging bias determiner 330 (e.g., a charging bias power supply) that applies a predetermined charging bias to the charger 60 depicted in FIG. 2 is connected to the controller 500 through the I/O interface 505. A developing bias determiner 340 (e.g., a developing bias power supply) that applies a predetermined developing bias to the developing roller 61a of the developing device 61 depicted in FIG. 2 is connected to the controller 500. Further, a primary transfer bias determiner 350 (e.g., a primary transfer bias power supply) that applies a predetermined primary transfer bias to the primary transfer devices 62S, 62Y, 62M, 62C, and 62K depicted in FIG. 1 is connected to the controller 500 through the I/O interface 505.

An exposure determiner 360 (e.g., a light source power supply) that applies a predetermined voltage or supplies a predetermined electric current to a light source of the exposure device 21 is connected to the controller 500. The sheet feeder 200, the scanner 300, and the ADF 400 are connected to the controller 500 through the I/O interface 505. The controller 500 controls various components based on a target control value of the image forming condition.

The ROM 503 or the RAM 504 stores a conversion table storing information about conversion of an output value of the toner density sensor 312 to a toner adhesion amount per unit area, for example. The ROM 503 or the RAM 504 further stores the target control value of the image forming condition for each of the image forming devices 18S, 18Y, 18M, 18C, and 18K under each of the image forming modes available in the copier 600. The stored image forming condition includes the charging bias, the developing bias, the exposure amount, and the primary transfer bias.

Instead of the computer such as the micro computer, the controller 500 may be constructed of an integrated circuit (IC) or the like serving as a semiconductor circuit clement manufactured for control in the copier 600.

A description is provided of a process control performed by the controller 500 having the configuration described above.

The controller 500 conducts an image density control also called a process control at a predetermined time. The predetermined time includes times off the image forming operation such as a time when the copier 600 is powered on, a time before a print job, that is, an image forming operation, starts, a time after a predetermined number of transfer sheets P (e.g., 500 sheets) is printed, that is, a time when the image forming operation is interrupted, and a time after the print job, that is, the image forming operation, is finished.

Under the image density control (e.g., a potential control) of the copier 600, at least one of the image forming devices 18S, 18Y, 18M, 18C, and 18K produces a plurality of toner patterns of a plurality of pattern toner images having a plurality of different toner adhesion amounts, respectively. The potential sensor 70 disposed opposite the at least one of the photoconductors 40S, 40Y, 40M, 40C, and 40K detects the potential of an electrostatic latent image of the pattern toner image. The toner adhesion sensor 310 detects the toner adhesion amount of toner of the toner pattern having the pattern toner image transferred onto the intermediate transfer belt 10. The toner density sensor 312 detects the toner density of toner contained inside the developing device 61 of the at least one of the image forming devices 18S, 18Y, 18M, 18C, and 18K.

The controller 500 calculates the target control value (e.g., the image forming condition) of each of the charging bias, the developing bias, the exposure amount (e.g., an applied voltage or an applied electric current), and the toner density based on the detection results of the potential sensor 70, the toner adhesion sensor 310, and the toner density sensor 312 to adjust the toner adhesion amount to a predetermined target adhesion amount. For example, the controller 500 receives values relating to a toner adhesion amount of toner of the toner pattern that is detected by the toner adhesion sensor 310, a toner density of toner contained inside the developing device 61 that is detected by the toner density sensor 312, a surface potential of the photoconductor 40 after exposure that is detected by the potential sensor 70, a present developing bias, and a target toner adhesion amount. Upon receipt of those values, the controller 500 outputs, as the image forming condition, the charging bias of the charger 60, the developing bias of the developing device 61, the exposure amount (e.g., the applied voltage or the applied electric current) of the exposure device 21, the target control value of each of the charging bias, the developing bias, and the exposure amount, and the target control value of the toner density of toner contained inside the developing device 61. Based on the optimum image forming condition, that is, the target control values, the controller 500 controls bias application and toner supply by the various components of the copier 600 for a subsequent image forming operation, thus retaining the image density stably.

With reference to FIGS. 1 to 3, a description is provided of a primary image forming condition determination control and a secondary image forming condition determination control of the image density control performed by the controller 500.

The primary image forming condition determination control determines the image forming condition by using a toner pattern formed by all of the five image forming devices 18S, 18Y, 18M, 18C, and 18K. The secondary image forming condition determination control determines the image forming condition by using a toner pattern formed by a part of the five image forming devices 18S, 18Y, 18M, 18C, and 18K, that is, the image forming device 18S only. During the secondary image forming condition determination control, the image forming devices 18Y, 18M, 18C, and 18K not used for formation of the toner pattern are deactuated and the photoconductors 40Y, 40M, 40C, and 40K incorporated therein are isolated from the intermediate transfer belt 10.

A detailed description is now given of the primary image forming condition determination control.

Under the primary image forming condition determination control, since all of the five image forming devices 18S, 18Y, 18M, 18C, and 18K are used, the image density control is performed in a state in which all of the photoconductors 40S, 40Y, 40M, 40C, and 40K contact the intermediate transfer belt 10. Under the primary image forming condition determination control, all of the photoconductors 40S, 40Y, 40M, 40C, and 40K are charged by the chargers 60S, 60Y, 60M, 60C, and 60K, respectively. The exposure device 21 forms an electrostatic latent image to be developed into a pattern toner image on each of the photoconductors 40S, 40Y, 40M, 40C, and 40K. The developing devices 61S, 61Y, 61M, 61C, and 61K develop the electrostatic latent image formed on the respective photoconductors 40S, 40Y, 40M, 40C, and 40K into the pattern toner image. The primary transfer devices 62S, 62Y, 62M, 62C, and 62K primarily transfer the pattern toner image formed on the respective photoconductors 40S, 40Y, 40M, 40C, and 40K onto the intermediate transfer belt 10. Thus, the intermediate transfer belt 10 bears a toner pattern formed with a plurality of pattern toner images having a plurality of different toner adhesion amounts for five colors, respectively.

Under the primary image forming condition determination control, the potential sensor 70 of the respective image forming devices 18S, 18Y, 18M, 18C, and 18K detects the potential of the electrostatic latent image to be developed into the pattern toner image. The toner adhesion sensor 310 detects the toner adhesion amount of toner of the pattern toner image in each color. The toner density sensor 312 detects the toner density of toner contained inside the respective developing devices 61S, 61Y, 61M, 61C, and 61K while each of the developing devices 61S, 61Y, 61M, 61C, and 61K forms the pattern toner image. Detection results of the potential sensor 70, the toner adhesion sensor 310, and the toner density sensor 312 are sent to the controller 500 that calculates the image forming condition based on the detection results and stores the calculated image forming condition as an image forming condition for process control in all colors, that is, a primary image forming condition. Accordingly, during a subsequent image forming operation in the print mode including the FCS print mode other than the S print mode, the controller 500 performs image forming control using the image forming condition for the respective image forming devices 18S, 18Y, 18M, 18C, and 18K under the image forming condition for process control in all colors.

A detailed description is now given of the secondary image forming condition determination control.

Under the secondary image forming condition determination control, since only the upstream image forming device 18S disposed upstream from the image forming devices 18Y, 18M, 18C, and 18K in the rotation direction D10 of the intermediate transfer belt 10 is used, the image density control is performed in a state in which only the photoconductor 40S contacts the intermediate transfer belt 10. Under the secondary image forming condition determination control, the single photoconductor 40S among the five photoconductors 40S, 40Y, 40M, 40C, and 40K is charged by the charger 60S. The exposure device 21 forms an electrostatic latent image to be developed into a pattern toner image on the photoconductor 40S. The developing device 61S develops the electrostatic latent image formed on the photoconductor 40S into the pattern toner image. The primary transfer device 62S primarily transfers the pattern toner image formed on the photoconductor 40S onto the intermediate transfer belt 10. Thus, the intermediate transfer belt 10 bears a toner pattern including a plurality of pattern toner images having a plurality of different toner adhesion amounts for clear color, respectively.

Under the secondary image forming condition determination control, the potential sensor 70 of the image forming device 18S detects the potential of the electrostatic latent image to be developed into the pattern toner image. The toner adhesion sensor 310 for clear color detects the toner adhesion amount of toner of the pattern toner image in clear color. The toner density sensor 312 for the developing device 61S detects the toner density of toner contained inside the developing device 61S while the developing device 61S forms the pattern toner image in clear color. Detection results of the potential sensor 70, the toner adhesion sensor 310, and the toner density sensor 312 are sent to the controller 500 that calculates the image forming condition based on the detection results and stores the calculated image forming condition as an image forming condition for process control in clear color, that is, a secondary image forming condition. Accordingly, during a subsequent image forming operation in the S print mode, the controller 500 performs image forming control using the image forming condition for the image forming device 18S under the image forming condition for process control in clear color.

A description is provided of the image density control performed by the controller 500 of the copier 600.

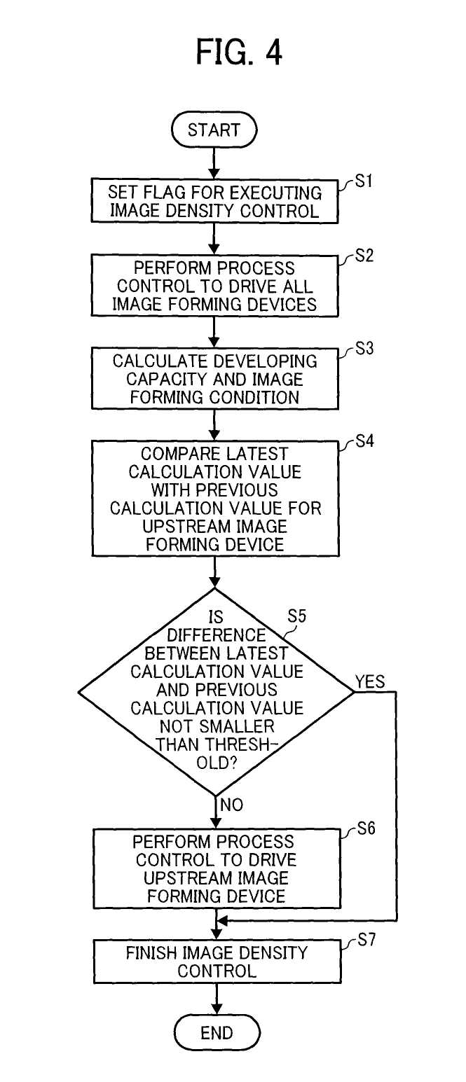

FIG. 4 is a flowchart showing the image density control conducted by the controller 500. At the predetermined time described above such as the time when the copier 600 is powered on, the time before the print job starts, the time after the predetermined number of transfer sheets P is printed, and the time after the print job is finished, the copier 600 sets a flag for executing the image density control in step S1, thus performing the image density control also called the process control. No image data is necessary to perform the image density control.

When executing the image density control, the controller 500 performs a process control to drive all of the image forming devices 18S, 18Y, 18M, 18C, and 18K, that is, the primary image forming condition determination control described above in step S2, thus determining an optimum image forming condition in the FCS print mode in which all of the image forming devices 18S, 18Y, 18M, 18C, and 18K are driven. The controller 500 calculates the optimum image forming condition and developing capacity in the FCS print mode for the respective image forming devices 18S, 18Y, 18M, 18C, and 18K in step S3. The developing capacity defines a toner adhesion amount relative to a developing potential, that is, a potential difference between a developing bias Vb and an exposure device potential VL. Even under an identical developing potential, the greater the toner adhesion amount, the greater the developing capacity. According to the primary image forming condition determination control, the controller 500 calculates a latest image forming condition in the FCS print mode in which all of the image forming devices 18S, 18Y, 18M, 18C, and 18K are driven, updating the image forming condition in the FCS print mode stored in the memory of the controller 500.

In step S4, regarding the developing capacity and the image forming condition of the upstream image forming device 18S, the controller 500 compares a latest calculation value calculated under the primary image forming condition determination control with a previous calculation value calculated under the primary image forming condition determination control. In step S5, the controller 500 determines whether or not a difference between the latest calculation value and the previous calculation value is not smaller than a predetermined threshold. If the comparison shows that the difference is smaller than the threshold (YES in step S5), the controller 500 determines that the process control to drive the image forming device 18S only, that is, the secondary image forming condition determination control described above, is unnecessary, finishing the image density control in step S7.

Conversely, if the controller 500 determines that the difference is not smaller than the threshold (NO in step S5), the controller 500 determines that the process control to drive the image forming device 18S only, that is, the secondary image forming condition determination control described above, is necessary, performing the secondary image forming condition determination control immediately in step S6. According to the secondary image forming condition determination control, the controller 500 calculates the latest image forming condition in the S print mode in which only the image forming device 18S is driven, updating the image forming condition in the S print mode stored in the memory of the controller 500.

The threshold referred to during determination of the controller 500 in step S5 is provided for a plurality of conditions such as the charging bias, the developing bias, the exposure amount, and the primary transfer bias. For example, the threshold for the charging bias is applied to a difference between a charging bias under the latest image forming condition and a charging bias under the previous image forming condition. The same is applicable to the thresholds for the developing bias, the exposure amount, and the primary transfer bias. If the difference between the latest calculation value and the previous calculation value for all the conditions is smaller than the threshold, the controller 500 determines that the comparison result is smaller than the threshold and the secondary image forming condition determination control is unnecessary. Conversely, if the difference between the latest calculation value and the previous calculation value of one of the plurality of conditions is not smaller than the threshold, the controller 500 determines that the comparison result is not smaller than the threshold and the secondary image forming condition determination control is necessary.

A description is provided of the image forming condition during an image forming operation according to image data.

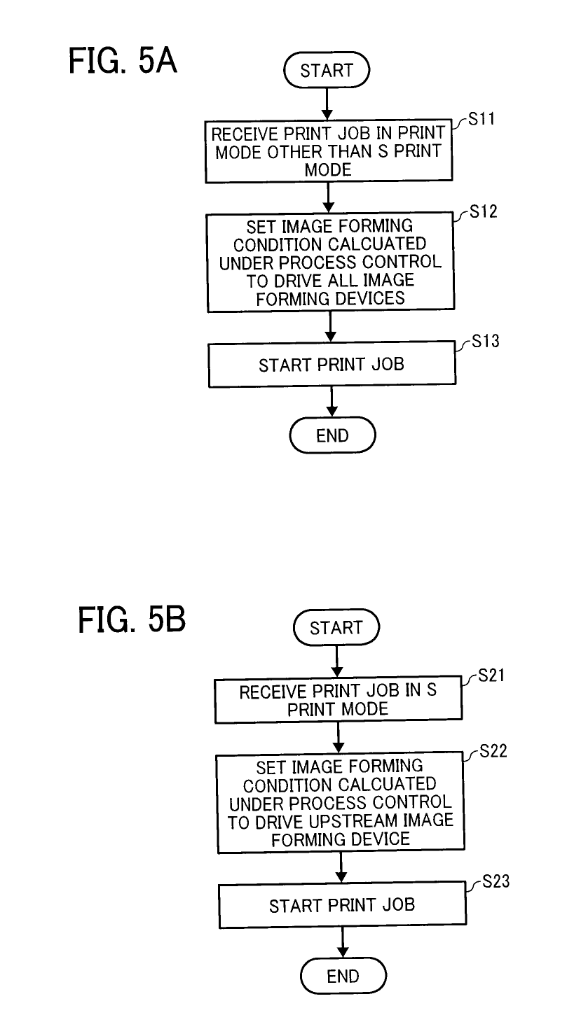

FIG. 5A is a flowchart showing a control for setting the image forming condition in the print mode other than the S print mode. As shown in FIG. 5A, the copier 600 receives a print job in the print mode other than the S print mode to form a toner image according to image data in step S11. In step S12, the controller 500 sets the image forming condition calculated under the primary image forming condition determination control, that is, the process control to drive all of the image forming devices 18S, 18Y, 18M, 18C, and 18K, to the image forming devices 18S, 18Y, 18M, 18C, and 18K used for the print job. In step S13, the controller 500 starts the print job using the set image forming condition.

FIG. 5B is a flowchart showing a control for setting the image forming condition in the S print mode. As shown in FIG. 5B, the copier 600 receives a print job in the S print mode to form a toner image according to image data in step S21. In step S22, the controller 500 sets the image forming condition calculated under the secondary image forming condition determination control, that is, the process control to drive the upstream image forming device 18S, to the image forming device 18S used for the print job. In step S23, the controller 500 starts the print job using the set image forming condition.

The copier 600 according to this exemplary embodiment employs the image forming condition that varies between the S print mode using the upstream image forming device 18S only disposed upstream from the image forming devices 18Y, 18M, 18C, and 18K in the rotation direction D10 of the intermediate transfer belt 10 among the five image forming devices 18S, 18Y, 18M, 18C, and 18K and the print modes other than the S print mode due to the reasons described below.

Under the primary image forming condition determination control, the controller 500 determines the image forming condition in a state in which all of the photoconductors 40S, 40Y, 40M, 40C, and 40K contact the intermediate transfer belt 10. Accordingly, the controller 500 sets the optimum image forming condition appropriate for the FCS print mode using all of the image forming devices 18S, 18Y, 18M, 18C, and 18K. However, the controller 500 may not set the optimum image forming condition appropriate for the print modes other than the FCS print mode. For example, a clear toner pattern produced by the upstream image forming device 18S with clear toner passes through four primary transfer nips formed between the intermediate transfer belt 10 and the four photoconductors 40Y, 40M, 40C, and 40K of the four image forming devices 18Y, 18M, 18C, and 18K, respectively. Hence, the clear toner pattern is susceptible to reverse transfer more frequently during the primary image forming condition determination control and therefore is more susceptible to variation in the toner adhesion amount between the monochrome print mode immune from adverse effect of reverse transfer and the primary image forming condition determination control. To address this circumstance, in the S print mode using the image forming device 18S only, the copier 600 performs the print job under the image forming condition calculated under the secondary image forming condition determination control that determines the image forming condition by using the image forming device 18S only.

A description is provided of selective activation of the primary image forming condition determination control and the secondary image forming condition determination control.

The copier 600 selectively performs the primary image forming condition determination control that drives all of the image forming devices 18S, 18Y, 18M, 18C, and 18K and the secondary image forming condition determination control that drives the image forming device 18S only as a predetermined image forming device, thus changing the image forming condition according to the print mode. As a configuration to perform the primary image forming condition determination control and the secondary image forming condition determination control, the secondary image forming condition determination control may be always performed after the primary image forming condition determination control. However, if the secondary image forming condition determination control is performed after the primary image forming condition determination control even when the secondary image forming condition determination control is unnecessary, the copier 600 may cause the user to wait longer before the image density control finishes or increase toner consumption.

To address this circumstance, the controller 500 of the copier 600 according to this exemplary embodiment determines whether or not to perform the secondary image forming condition determination control based on the developing capacity and the image forming condition of the upstream image forming device 18S that are calculated under the primary image forming condition determination control. The controller 500 calculates the developing capacity and the image forming condition based on a detection result provided by the toner adhesion sensor 310. That is, the controller 500 of the copier 600 determines whether or not to perform the secondary image forming condition determination control based on the detection result provided by the toner adhesion sensor 310 under the primary image forming condition determination control.

If the secondary image forming condition determination control is necessary, when a toner image is formed under an image forming condition identical to a previous image forming condition under the secondary image forming condition determination control, the toner image may not achieve a desired image density due to an environmental change, degradation of the components of the copier 600, and the like. In this case, under the primary image forming condition determination control susceptible to adverse effect of reverse transfer, the controller 500 may not set the image forming condition appropriate for the S print mode using the image forming device 18S only. However, when the environmental change, degradation of the components of the copier 600, and the like are great enough to degrade formation of a clear toner image with the image forming device 18S to such an extent that the secondary image forming condition determination control is necessary, such circumstance may cause adverse effect on image formation using all of the image forming devices 18S, 18Y, 18M, 18C, and 18K. The adverse effect may appear as change in the image forming condition needed to obtain a desired toner adhesion amount and change in the developing capacity.

During the primary image forming condition determination control, the clear toner pattern produced by the upstream image forming device 18S with clear toner passes through the four primary transfer nips formed between the intermediate transfer belt 10 and the four photoconductors 40Y, 40M, 40C, and 40K of the four image forming devices 18Y, 18M, 18C, and 18K, respectively. Accordingly, if the image forming condition and the developing capacity for the image forming device 18S during the primary image forming condition determination control are unchanged from previous detection results, the controller 500 assumes that reverse transfer to the clear toner pattern does not change image formation of the image forming device 18S.

Accordingly, the controller 500 of the copier 600 according to this exemplary embodiment compares the latest image forming condition and developing capacity calculated under the primary image forming condition determination control using all of the image forming devices 18S, 18Y, 18M, 18C, and 18K with the previous image forming condition and developing capacity calculated under the primary image forming condition determination control. If the controller 500, after the comparison, determines that a difference between the latest image forming condition and developing capacity and the previous image forming condition and developing capacity is not smaller than the threshold, the controller 500 performs the secondary image forming condition determination control using the image forming device 18S only.

Conversely, if the controller 500 determines that the difference between the latest image forming condition and developing capacity calculated under the primary image forming condition determination control and the previous image forming condition and developing capacity is smaller than the threshold, the controller 500 does not perform the secondary image forming condition determination control. Accordingly, the copier 600 reduces the waiting time for the user to wait before the image density control finishes and toner consumption, which are spent for the image density control. Additionally, if the controller 500 determines that the difference between the latest image forming condition and developing capacity and the previous image forming condition and developing capacity is not smaller than the threshold, the controller 500 performs the secondary image forming condition determination control and the S print mode according to the calculated image forming condition. Consequently, the copier 600 attains a predetermined image density precisely regardless of the print mode.

In a configuration that performs the S print mode, upon receipt of a print job in the S print mode, the controller 500 performs the secondary image forming condition determination control using the image forming device 18S only. In this case, when printing on a single transfer sheet P in the FCS print mode, a single transfer sheet P in the S print mode, another single transfer sheet P in the FCS print mode, and another single transfer sheet P in the S print mode, the controller 500 may perform the secondary image forming condition determination control whenever switching the print mode. Hence, the waiting time for the user to wait before the image density control finishes and toner consumption may increase substantially depending on usage of the print modes. To address this circumstance, the controller 500 of the copier 600 according to this exemplary embodiment performs the secondary image forming condition determination control immediately after the primary image forming condition determination control performed at the predetermined time described above, thus allowing the user to wait shorter before the image density control finishes and reducing toner consumption regardless of the print mode or the like.

Alternatively, the user may not use the S print mode or may barely use the S print mode. In this case, if the controller 500 performs the secondary image forming condition determination control using the image forming device 18S only, clear toner may be wasted. To address this circumstance, for the user who does not use the S print mode, the copier 600 may provide a “Disable the S print mode” option to turn off the S print mode.

If clear toner is not used in a print job for a long time, clear toner, even during usage under the primary image forming condition determination control, is wasted. To address this circumstance, for the user who does not use clear toner for a long time, the copier 600 may provide a “Do not use clear toner” option to turn off the S print mode. In this case, the copier 600 does not drive the image forming device 18S even under the primary image forming condition determination control performed at the predetermined time, thus driving the other four image forming devices 18Y, 18M, 18C, and 18K to perform the primary image forming condition determination control.

According to the exemplary embodiments described above, the S print mode is used as a particular color image forming mode that forms a toner image by using a part of the image forming devices 18S, 18Y, 18M, 18C, and 18K, that is, a particular at least one of the image forming devices 18S, 18Y, 18M, 18C, and 18K preset. In the particular color image forming mode, a toner image is formed based on the image forming condition calculated under a particular color image forming condition determination control that determines the image forming condition by using the particular at least one of the image forming devices 18S, 18Y, 18M, 18C, and 18K. The particular color image forming condition determination control is performed separately from an all-color image forming condition determination control that determines the image forming condition by using all of the image forming devices 18S, 18Y, 18M, 18C, and 18K.

A description is provided of the particular color image forming mode.

The particular color image forming mode is not limited to the S print mode using the image forming device 18S only. The particular color image forming mode may be the K print mode using the image forming device 18K only or the FC print mode using the four image forming devices 18Y, 18M, 18C, and 18K other than the image forming device 18S. The image forming device 18K, as it is disposed downstream from the image forming devices 18S, 18Y, 18M, and 18C in the rotation direction D10 of the intermediate transfer belt 10, is immune from decrease in the toner adhesion amount of black toner to the intermediate transfer belt 10 due to reverse transfer. However, the image forming device 18K may suffer from change in transfer rate depending on one or more of clear, yellow, magenta, and cyan toner images on the intermediate transfer belt 10 when a black toner image formed on the photoconductor 40K is primarily transferred onto the intermediate transfer belt 10. In order to prevent change in transfer rate from adversely affecting the toner image, the process control in monochrome may be performed even for the downstream image forming device 18K. Alternatively, if the copier 600 provides the monochrome mode using the single image forming device 18 other than the image forming devices 18S and 18K, the bicolor mode, the tricolor mode, and the quadcolor mode, those modes may be defined as the particular color image formation mode as long as they do not use all of the image forming devices 18S, 18Y, 18M, 18C, and 18K.

Even if the particular color image forming mode is not the print mode using the upstream image forming device 18S only, the controller 500 compares the latest calculation values of the image forming condition and the developing capacity calculated under the primary image forming condition determination control with the previous calculation values calculated under the primary image forming condition determination control. If the controller 500, after the comparison, determines that the difference between the latest image forming condition and developing capacity and the previous image forming condition and developing capacity is not smaller than the threshold, the controller 500 performs the secondary image forming condition determination control using the image forming device 18 only that is used in the particular color image forming mode due to the reasons described below.

The clear toner pattern produced by the upstream image forming device 18S with clear toner passes through the four primary transfer nips formed between the intermediate transfer belt 10 and the four photoconductors 40Y, 40M, 40C, and 40K of the four image forming devices 18Y, 18M, 18C, and 18K, respectively. Accordingly, if the latest calculation values of the image forming condition and the developing capacity for the image forming device 18S during the primary image forming condition determination control using all of the image forming devices 18S, 18Y, 18M, 18C, and 18K are unchanged from the previous calculation values, the controller 500 may assume that latest reverse transfer is unchanged from previous reverse transfer relating to all of the image forming devices 18S, 18Y, 18M, 18C, and 18K. Even if the particular color image forming mode is any print mode, the controller 500 compares the latest calculation values of the image forming condition and the developing capacity relating to the upstream image forming device 18S with the previous calculation values. Accordingly, control performed by the controller 500 is simplified at reduced manufacturing costs.

However, if the latest calculation values of the image forming condition and the developing capacity for the upstream image forming device 18S are unchanged from the previous calculation values, the controller 500 may assume that total reverse transfer of toner of the clear toner pattern at the four primary transfer nips formed between the intermediate transfer belt 10 and the four image forming devices 18Y, 18M, 18C, and 18K remains unchanged. Even if the reverse transfer rate of the clear toner pattern is unchanged, the reverse transfer rate of other toner pattern (e.g., yellow, magenta, cyan, and black toner patterns) may be changed. Alternatively, even if the reverse transfer rate is unchanged, the controller 500 may not detect change in the optimum image forming condition and developing capacity resulting from degradation in the components constituting each of the image forming devices 18S, 18Y, 18M, 18C, and 18K, even if the controller 500 conducts comparison in the image forming condition and the developing capacity of the upstream image forming device 18S.

To address those circumstances, if the particular color image forming mode is not the print mode using the upstream image forming device 18S only, the controller 500 compares the latest calculation values of the image forming condition and the developing capacity with the previous calculation values calculated under the primary image forming condition determination control for the image forming device 18 used in the particular color image forming mode.

For one example, if the particular color image forming mode is the K print mode, the controller 500 compares the latest calculation values of the image forming condition and the developing capacity relating to the image forming device 18K calculated under the primary image forming condition determination control with the previous calculation values thereof. If the controller 500 determines that the difference between the latest calculation values and the previous calculation values is not smaller than the predetermined threshold, the controller 500 performs the process control to drive the image forming device 18S only as the secondary image forming condition determination control.

For another example, if the particular color image forming mode is the FC print mode, the controller 500 compares the latest calculation values of the image forming condition and the developing capacity relating to the four image forming devices 18Y, 18M, 18C, and 18K other than the image forming device 18S calculated under the primary image forming condition determination control with the previous calculation values thereof. If the controller 500 determines that the difference between the latest calculation values and the previous calculation values is not smaller than the predetermined threshold, the controller 500 performs the process control to drive the four image forming devices 18Y, 18M, 18C, and 18K as the secondary image forming condition determination control.

That is, the controller 500 compares the latest calculation values of the image forming condition and the developing capacity calculated under the primary image forming condition determination control with the previous calculation values thereof for the image forming device 18 used in the particular color image forming mode. Based on the comparison, the controller 500 determines whether or not to perform the process control to drive the image forming device 18 only used in the particular color image forming mode as the secondary image forming condition determination control. The controller 500, by comparison of the image forming condition and the like of the image forming device 18 used in the particular color image forming mode, detects change of the image forming device 18 used in the particular color image forming mode and therefore determines whether or not to perform the secondary image forming condition determination control precisely.

As shown in FIG. 1, the copier 600 according to the exemplary embodiments described above includes the plurality of image forming devices 18S, 18Y, 18M, 18C, and 18K. As shown in FIG. 2, each of the image forming devices 18S, 18Y, 18M, 18C, and 18K identified as the image forming device 18 includes the photoconductor 40 serving as a pre-transfer image bearer or a latent image bearer; the charger 60 that charges the outer circumferential surface of the photoconductor 40; and the developing device 61. The developing device 61 includes the developing roller 61a serving as a developer bearer applied with a developing bias to move toner particles carried on the developing roller 61a to an electrostatic latent image formed on the photoconductor 40, thus developing the electrostatic latent image into a toner image. As shown in FIG. 1, each of the primary transfer devices 62S, 62Y, 62M, 62C, and 62K serving as a transferor primarily transfers the toner image formed on the photoconductor 40 onto the intermediate transfer belt 10 serving as a transferred image bearer or an intermediate transferor. The copier 600 includes the exposure device 21 situated above the image forming devices 18S, 18Y, 18M, 18C, and 18K to form the electrostatic latent image on the charged outer circumferential surface of the photoconductor 40.

According to the exemplary embodiments described above, the image forming devices 18S, 18Y, 18M, 18C, and 18K include the photoconductors 40S, 40Y, 40M, 40C, and 40K, each of which serves as a latent image bearer that also serves as a pre-transfer image bearer that bears a toner image to be transferred onto the intermediate transfer belt 10 serving as a transferred image bearer that bears the plurality of toner images transferred from the plurality of photoconductors 40S, 40Y, 40M, 40C, and 40K. However, the image forming devices 18S, 18Y, 18M, 18C, and 18K may have other construction. For example, each of the image forming devices 18S, 18Y, 18M, 18C, and 18K may include an intermediate transferor separately from a latent image bearer. A toner image formed on the intermediate transferor may be transferred onto a transferor that bears a plurality toner images transferred thereto.

The exemplary embodiments described above attain advantages below in a plurality of aspects A to I.

A description is provided of the aspect A.

As shown in FIG. 1, an image forming apparatus (e.g., the copier 600) includes a transferred image bearer (e.g., the intermediate transfer belt 10 and a transfer sheet P) movable in a predetermined direction of motion (e.g., the rotation direction D10 and the sheet conveyance direction) and a plurality of image forming devices (e.g., the image forming devices 18S, 18Y, 18M, 18C, and 18K) arranged in the direction of motion of the transferred image bearer. Each image forming device includes a pre-transfer image bearer (e.g., the photoconductors 40S, 40Y, 40M, 40C, and 40K) to bear a toner image to be transferred onto the transferred image bearer.

As shown in FIG. 3, the image forming apparatus further includes a controller (e.g., the controller 500) to selectively perform a plurality of image forming modes including a multi-color image forming mode, that is, an all-color image forming mode (e.g., the FCS print mode), that forms the toner image with all of the plurality of image forming devices and a particular color image forming mode (e.g., the S print mode) that forms the toner image with a part of the plurality of image forming devices, that is, a particular at least one of the plurality of image forming devices (e.g., the image forming device 18S). The controller, serving as an image forming controller, performs an image forming control that forms the toner image on the pre-transfer image bearer of the particular at least one of the plurality of image forming devices selected depending on the image forming mode according to image data and transfers the toner image formed on the pre-transfer image bearer onto the transferred image bearer (e.g., the intermediate transfer belt 10 or the transfer sheet P serving as a recording medium conveyed by the intermediate transfer belt 10). The image forming apparatus further includes a toner adhesion detector (e.g., the toner adhesion sensor 310) disposed opposite the transferred image bearer to detect a toner adhesion amount of toner adhered to the transferred image bearer.

The controller, serving as an image forming condition determiner, performs a primary image forming condition determination control (e.g., the all-color image forming condition determination control) and a secondary image forming condition determination control (e.g., the particular color image forming condition determination control).

The primary image forming condition determination control forms the toner image for multi-color image density adjustment (e.g., an all-color toner pattern) on the transferred image bearer with all of the plurality of image forming devices, detects the toner adhesion amount of the toner of the toner image for multi-color image density adjustment with the toner adhesion detector, and determines a primary image forming condition for each of the plurality of image forming devices in the multi-color image forming mode based on the toner adhesion amount detected by the toner adhesion detector.

The secondary image forming condition determination control forms the toner image for particular color image density adjustment (e.g., a clear toner pattern) on the transferred image bearer with the particular at least one of the plurality of image forming devices, detects the toner adhesion amount of the toner of the toner image for particular color image density adjustment with the toner adhesion detector, and determines a secondary image forming condition for the particular at least one of the plurality of image forming devices in the particular color image forming mode based on the toner adhesion amount detected by the toner adhesion detector.

The image forming controller performs the primary image forming condition determination control at a predetermined time and determines whether or not to perform the secondary image forming condition determination control based on the toner adhesion amount detected by the toner adhesion detector under the primary image forming condition determination control.

Accordingly, as described in the exemplary embodiments, the controller, by performing the all-color image forming condition determination control and the particular color image forming condition determination control, determines the appropriate image forming condition in each of the all-color image forming mode and the particular color image forming mode. Since the controller determines the appropriate image forming condition in each of the plurality of image forming modes, the controller suppresses variation in image density and color of the toner image formed on the recording medium between the plurality of image forming modes that uses different image forming devices.

The controller determines whether or not to perform the particular color image forming condition determination control based on the detection result provided by the toner adhesion detector under the all-color image forming condition determination control. Under the all-color image forming condition determination control, the toner adhesion detector also detects the toner adhesion amount of the toner of the toner image formed by the image forming device used in the particular color image forming mode. Even if the controller does not determine the appropriate image forming condition for the particular color image forming mode under the all-color image forming condition determination control only, the controller determines whether or not change occurs in an environment or the image forming device used in the particular color image forming mode, which is great enough to require change in the image forming condition in the particular color image forming mode. Accordingly, the controller performs the particular color image forming condition determination control only when the controller determines that it is necessary to change the image forming condition in the particular color image forming mode based on the detection result provided by the toner adhesion detector under the all-color image forming condition determination control. Consequently, the controller performs the particular color image forming condition determination control only when it is necessary, suppressing increase in toner consumption and the waiting time for the user to wait before the image density control finishes that may arise when the particular color image forming condition determination control is conducted separately from the all-color image forming condition determination control.

Thus, the image forming apparatus in the aspect A suppresses variation in image density and color of the toner image formed on the recording medium between the plurality of image forming modes that uses different image forming devices, while suppressing increase in toner consumption and the waiting time for the user.

A description is provided of the aspect B.

As shown in FIGS. 1 and 3, according to the aspect A, the controller (e.g., the controller 500), serving as the image forming controller, compares a latest image forming condition of an upstream image forming device (e.g., the image forming device 18S) disposed upstream from other image forming devices of the plurality of image forming devices in the direction of motion of the transferred image bearer that is determined under the all-color image forming condition determination control, that is, the primary image forming condition determination control, with a previous image forming condition of the upstream image forming device that is determined under the all-color image forming condition determination control. If a difference between the latest image forming condition and the previous image forming condition exceeds a predetermined range, for example, is not smaller than a predetermined threshold, the controller determines that the particular color image forming condition determination control, that is, the secondary image forming condition determination control, is necessary, thus determining to perform the particular color image forming condition determination control. Otherwise, the controller determines that the particular color image forming condition determination control is not necessary.

Accordingly, as described in the exemplary embodiments, the controller, by comparing a latest calculation value of the image forming condition of the upstream image forming device with a previous calculation value thereof, determines whether or not to perform the particular color image forming condition determination control. Consequently, the controller performs the particular color image forming condition determination control only when it is necessary, suppressing increase in toner consumption and the waiting time for the user to wait before the image density control finishes.

A description is provided of the aspect C.

According to the aspect A, the controller (e.g., the controller 500), serving as the image forming controller, compares a latest image forming condition of the particular image forming device (e.g., the image forming device 18S) that is determined under the all-color image forming condition determination control with a previous image forming condition thereof. If a difference between the latest image forming condition and the previous image forming condition exceeds a predetermined range, for example, is not smaller than a predetermined threshold, the controller determines that the particular color image forming condition determination control, that is, the secondary image forming condition determination control, is necessary, thus determining to perform the particular color image forming condition determination control. Otherwise, the controller determines that the particular color image forming condition determination control is not necessary.

Accordingly, as described in the exemplary embodiments, the controller, by comparing a latest calculation value of the image forming condition of the particular image forming device with a previous calculation value thereof, determines whether or not to perform the particular color image forming condition determination control. Consequently, the controller performs the particular color image forming condition determination control only when it is necessary, suppressing increase in toner consumption and the waiting time for the user to wait before the image density control finishes. Additionally, the controller, by comparison of the image forming condition of the image forming device used in the particular color image forming mode, detects change of the image forming device used in the particular color image forming mode and therefore determines whether or not to perform the particular color image forming condition determination control precisely.

A description is provided of the aspect D.

According to any one of the aspects A to C, the controller (e.g., the controller 500), serving as the image forming controller, performs the particular color image forming condition determination control at a time corresponding to a time when the all-color image forming condition determination control, that is, the primary image forming condition determination control, is performed, if the controller determines to perform the particular color image forming condition determination control, that is, the secondary image forming condition determination control.

Accordingly, as described in the exemplary embodiments, the time when the controller performs the particular color image forming condition determination control depends on the time when the controller performs the all-color image forming condition determination control and therefore does not depend on image data instructing to perform the particular color image forming mode such as the S print mode. Accordingly, it is not necessary to perform the particular color image forming condition determination control according to the image forming mode whenever the image forming mode switches according to the image data. Consequently, compared to a configuration in which the controller performs the particular color image forming condition determination control whenever it receives image data instructing to perform the particular color image forming condition mode, the image forming apparatus reduces toner consumption and shortens the waiting time for the user to wait before the image density control finishes.

A description is provided of the aspect E.

According to any one of the aspects A to D, the controller (e.g., the controller 500), serving as the image forming controller, performs the particular color image forming condition determination control, that is, the secondary image forming condition determination control, immediately after it performs the all-color image forming condition determination control, that is, the primary image forming condition determination control, if the controller determines to perform the particular color image forming condition determination control.

Accordingly, as described in the exemplary embodiments, even if the particular color image forming condition determination control is performed, the controller performs the particular color image forming condition determination control immediately after the all-color image forming condition determination control is performed, reducing the waiting time for the user to wait before the image density control finishes.

A description is provided of the aspect F.

According to any one of the aspects A to E, the particular image forming device is the upstream image forming device (e.g., the image forming device 18S) disposed upstream from other image forming devices of the plurality of image forming devices in the direction of motion of the transferred image bearer.

Accordingly, as described in the exemplary embodiments, the controller determines the optimum image forming condition in the image forming mode such as the S print mode that uses the upstream image forming device only that is more susceptible to reverse transfer than other image forming devices under the all-color image forming condition determination control.

A description is provided of the aspect G.

According to any one of the aspects A to F, the plurality of image forming modes includes the all-color image forming mode (e.g., the FCS print mode), an upstream image forming mode (e.g., the S print mode), a non-upstream image forming mode (e.g., the FC print mode), and a downstream image forming mode (e.g., the K print mode). The upstream image forming mode forms the toner image with the upstream image forming device (e.g., the image forming device 18S) only disposed upstream from other image forming devices of the plurality of image forming devices in the direction of motion of the transferred image bearer. The non-upstream image forming mode forms the toner image with at least one image forming device other than the upstream image forming device, that is, a non-upstream image forming device disposed downstream from the upstream image forming device in the direction of motion of the transferred image bearer. The downstream image forming mode forms the toner image with a downstream image forming device (e.g., the image forming device 18K) only disposed downstream from other image forming devices of the plurality of image forming devices in the direction of motion of the transferred image bearer. The controller (e.g., the controller 500), serving as the image forming controller, determines the image forming mode to selectively perform based on the image data of the toner image to be formed.

Accordingly, the exemplary embodiments described above are applicable to an image forming apparatus that provides four or more image forming modes. Thus, the image forming apparatus, even if it provides four or more image forming modes, suppresses variation in image density and color of the toner image formed on the recording medium between the plurality of image forming modes that uses different image forming devices, while suppressing increase in toner consumption and the waiting time for the user.

A description is provided of the aspect H.

According to any one of the aspects A to G, the image forming condition of the image forming device used in the image forming modes other than the particular color image forming mode, such as the FCS print mode, the FC print mode, and the K print mode, is the primary image forming condition of each image forming device determined under the all-color image forming condition determination control, that is, the primary image forming condition determination control.

Accordingly, as described in the exemplary embodiments, the controller sets the optimum image forming condition in the particular color image forming mode such as the S print mode separately from other image forming modes.

A description is provided of the aspect I.

According to any one of the aspects A to H, each of the primary image forming condition determined under the all-color image forming condition determination control, that is, the primary image forming condition determination control, and the secondary image forming condition determined under the particular color image forming condition determination control, that is, the secondary image forming condition determination control, is at least one of a charging condition (e.g., a charging bias), an exposure condition (e.g., the exposure amount), a developing condition (e.g., a developing bias), and a transfer condition (e.g., a primary transfer bias).

Accordingly, as described in the exemplary embodiments, the controller determines the optimum charging, exposure, developing, and transfer conditions for each image forming mode.

The present disclosure has been described above with reference to specific exemplary embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. An image forming apparatus comprising:
a transferred image bearer movable in a predetermined direction of motion;
a plurality of image forming devices arranged in the direction of motion of the transferred image bearer, each of which including a pre-transfer image bearer to bear a toner image to be transferred onto the transferred image bearer;
a toner adhesion detector disposed opposite the transferred image bearer to detect a toner adhesion amount of toner of the toner image adhered to the transferred image bearer; and
a controller operatively connected to the plurality of image forming devices and the toner adhesion detector to selectively perform a multi-color image forming mode that forms the toner image with the plurality of image forming devices and a particular color image forming mode that forms the toner image with a particular at least one of the plurality of image forming devices,
the controller to perform a primary image forming condition determination control to form the toner image for multi-color image density adjustment on the transferred image bearer with the plurality of image forming devices, detect the toner adhesion amount of the toner of the toner image for multi-color image density adjustment with the toner adhesion detector, and determine a primary image forming condition for each of the plurality of image forming devices in the multi-color image forming mode based on the toner adhesion amount detected by the toner adhesion detector and a secondary image forming condition determination control to form the toner image for particular color image density adjustment on the transferred image bearer with the particular at least one of the plurality of image forming devices, detect the toner adhesion amount of the toner of the toner image for particular color image density adjustment with the toner adhesion detector, and determine a secondary image forming condition for the particular at least one of the plurality of image forming devices in the particular color image forming mode based on the toner adhesion amount detected by the toner adhesion detector,
the controller to perform the primary image forming condition determination control at a predetermined time and determine whether or not to perform the secondary image forming condition determination control based on the toner adhesion amount detected by the toner adhesion detector under the primary image forming condition determination control.

2. The image forming apparatus according to claim 1,
wherein the controller compares a latest image forming condition of the particular at least one of the plurality of image forming devices that is determined under the primary image forming condition determination control with a previous image forming condition thereof, and
wherein, if a difference between the latest image forming condition and the previous image forming condition exceeds a predetermined range, the controller determines to perform the secondary image forming condition determination control.

3. The image forming apparatus according to claim 2, wherein the controller performs the secondary image forming condition determination control at a time corresponding to a time when the primary image forming condition determination control is performed if the controller determines to perform the secondary image forming condition determination control.

4. The image forming apparatus according to claim 2, wherein the controller performs the secondary image forming condition determination control immediately after the primary image forming condition determination control if the controller determines to perform the secondary image forming condition determination control.

5. The image forming apparatus according to claim 2, wherein the particular at least one of the plurality of image forming devices includes an upstream image forming device disposed upstream from other image forming devices of the plurality of image forming devices in the direction of motion of the transferred image bearer.

6. The image forming apparatus according to claim 1,
wherein the particular at least one of the plurality of image forming devices includes an upstream image forming device disposed upstream from other image forming devices of the plurality of image forming devices in the direction of motion of the transferred image bearer, and
wherein the controller selectively performs an upstream image forming mode that forms the toner image with the upstream image forming device.

7. The image forming apparatus according to claim 6,
wherein the particular at least one of the plurality of image forming devices further includes a non-upstream image forming device disposed downstream from the upstream image forming device in the direction of motion of the transferred image bearer, and
wherein the controller selectively performs a non-upstream image forming mode that forms the toner image with the non-upstream image forming device.

8. The image forming apparatus according to claim 7,
wherein the particular at least one of the plurality of image forming devices further includes a downstream image forming device disposed downstream from other image forming devices of the plurality of image forming devices in the direction of motion of the transferred image bearer, and
wherein the controller selectively performs a downstream image forming mode that forms the toner image with the downstream image forming device.

9. The image forming apparatus according to claim 8, wherein the controller determines to selectively perform one of the multi-color image forming mode, the upstream image forming mode, the non-upstream image forming mode, and the downstream image forming mode based on image data of the toner image to be formed.

10. The image forming apparatus according to claim 9, wherein the primary image forming condition determined under the multi-color image forming mode is applied to the upstream image forming mode, the non-upstream image forming mode, and the downstream image forming mode.

11. The image forming apparatus according to claim 10, wherein each of the primary image forming condition determined under the primary image forming condition determination control and the secondary image forming condition determined under the secondary image forming condition determination control includes at least one of a charging condition to charge the pre-transfer image bearer, an exposure condition to expose the charged pre-transfer image bearer to form an electrostatic latent image thereon, a developing condition to develop the electrostatic latent image into the toner image, and a transfer condition to transfer the toner image onto the transferred image bearer.

12. The image forming apparatus according to claim 1,
wherein each of the plurality of image forming devices includes:
a potential sensor disposed opposite the pre-transfer image bearer to detect a potential of an electrostatic latent image on the pre-transfer image bearer to be developed into the toner image;
a developing device disposed opposite the pre-transfer image bearer to develop the electrostatic latent image into the toner image; and
a toner density sensor disposed opposite the developing device to detect a toner density of fresh toner contained therein, and
wherein the controller determines the primary image forming condition and the secondary image forming condition based on the potential of the electrostatic latent image detected by the potential sensor and the toner density of the fresh toner detected by the toner density sensor.

13. The image forming apparatus according to claim 1, wherein the transferred image bearer includes one of an intermediate transfer belt and a recording medium.

14. The image forming apparatus according to claim 1, wherein the pre-transfer image bearer includes a photoconductor.

15. The image forming apparatus according to claim 1, wherein the toner adhesion detector includes an optical sensor.

16. An image forming method comprising:
setting a flag for executing an image density control;
performing a primary image forming condition determination control to drive a plurality of image forming devices;
calculating a developing capacity and a primary image forming condition for each of the plurality of image forming devices;
comparing a latest calculation value with a previous calculation value of the developing capacity and the primary image forming condition for an upstream image forming device disposed upstream from other image forming devices of the plurality of image forming devices in a direction of motion of a transferred image bearer;
determining that a difference between the latest calculation value and the previous calculation value is not smaller than a threshold; and
performing a secondary image forming condition determination control to drive the upstream image forming device.

17. The image forming method according to claim 16, further comprising:
receiving a print job in a print mode other than a clear print mode using clear toner;
setting the primary image forming condition calculated under the primary image forming condition determination control; and
starting the print job.

18. The image forming method according to claim 16, further comprising:
receiving a print job in a clear print mode using clear toner;
setting a secondary image forming condition calculated under the secondary image forming condition determination control; and
starting the print job.
